(19) United States
(12) Patent Application Publication
(10) Pub. No.: US 2018/0020612 A1
(43) Pub. Date: Jan. 25, 2018

(54) Rake Assembly

(71) Applicants: Dale Alexander, Knoxville, TN (US); Ann Alexander, Knoxville, TN (US)

(72) Inventors: Dale Alexander, Knoxville, TN (US); Ann Alexander, Knoxville, TN (US)

(21) Appl. No.: 15/218,963

(22) Filed: Jul. 25, 2016

(51) Int. Cl. A01D 7/10; A01G 1/12

(52) U.S. Cl. CPC A01D 7/10; A01G 1/125

(57) ABSTRACT

A rake assembly includes a raking unit that may be manipulated thereby facilitating the raking unit to rake debris. The raking unit has a first half and a second half. Each of the first half and the second half is positionable in a closed position. Thus, each of the first half and the second half grips the debris thereby facilitating the debris to be selectively dumped. A closing unit is movably coupled to the raking unit and the closing unit may be manipulated. The closing unit is operationally coupled to each of the first half and the second half. Thus, the closing unit selectively positions each of the first half and the second half in the closed position when the closing unit is manipulated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to rake devices and more particularly pertains to a new rake device being selectively positioned in a closed position to grip debris.

### BRIEF SUMMARY OF THE INVENTION

An embodiment of the disclosure meets the needs presented above by generally comprising a raking unit that may be manipulated thereby facilitating the raking unit to rake debris. The raking unit has a first half and a second half. Each of the first half and the second half is positionable in a closed position. Thus, each of the first half and the second half grips the debris thereby facilitating the debris to be selectively dumped. A closing unit is movably coupled to the raking unit and the closing unit may be manipulated. The closing unit is operationally coupled to each of the first half and the second half. Thus, the closing unit selectively positions each of the first half and the second half in the closed position when the closing unit is manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a rake assembly according to an embodiment of the disclosure in an open position.

FIG. 2 is a top view of an embodiment of the disclosure in a closed position.

FIG. 3 is a right side view of an embodiment of the disclosure in an open position.

FIG. 4 is a right side view of an embodiment of the disclosure in a closed position.

FIG. 5 is a bottom view of an embodiment of the disclosure in an open position.

### DETAILED DESCRIPTION OF THE INVENTION

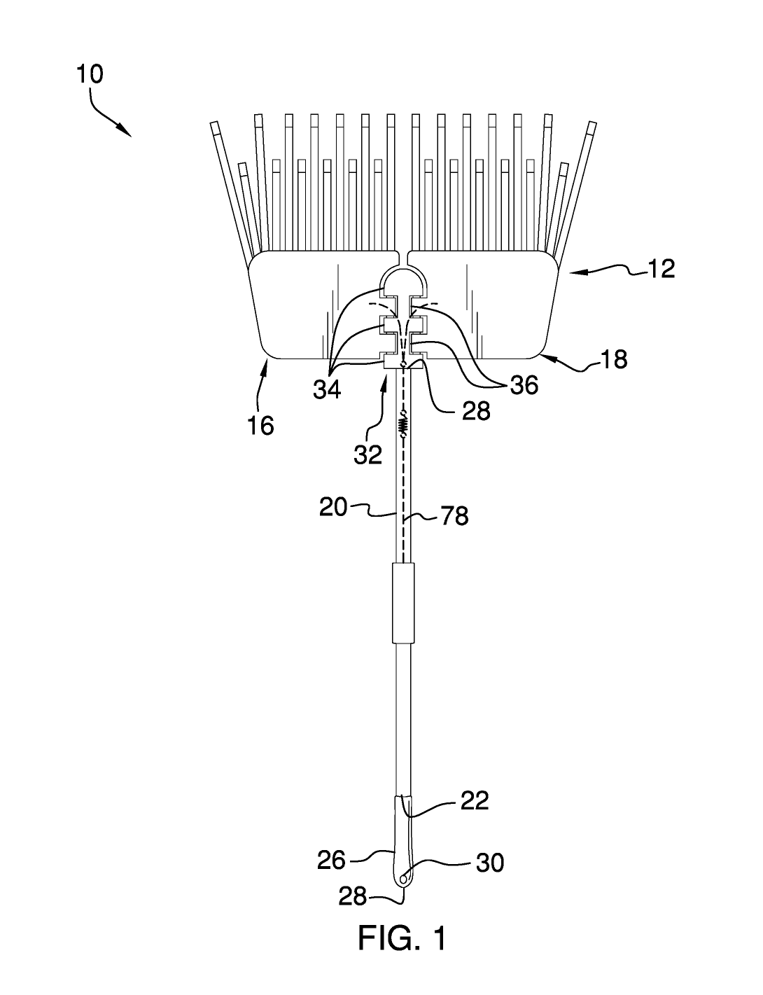

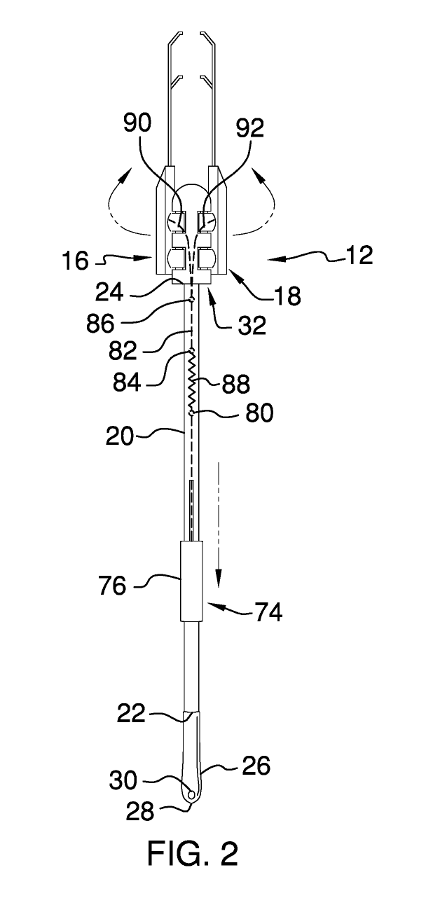

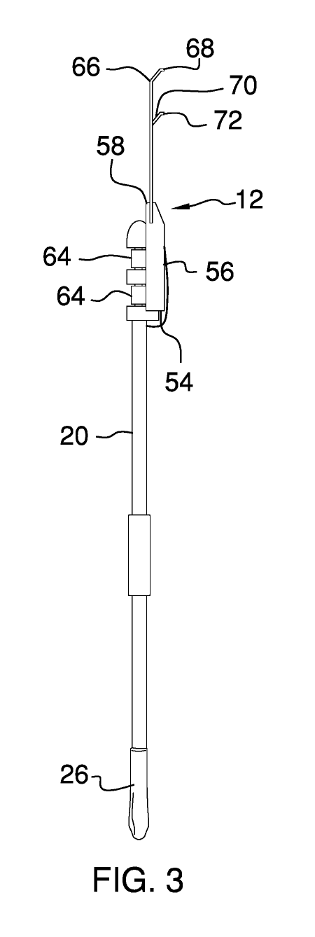

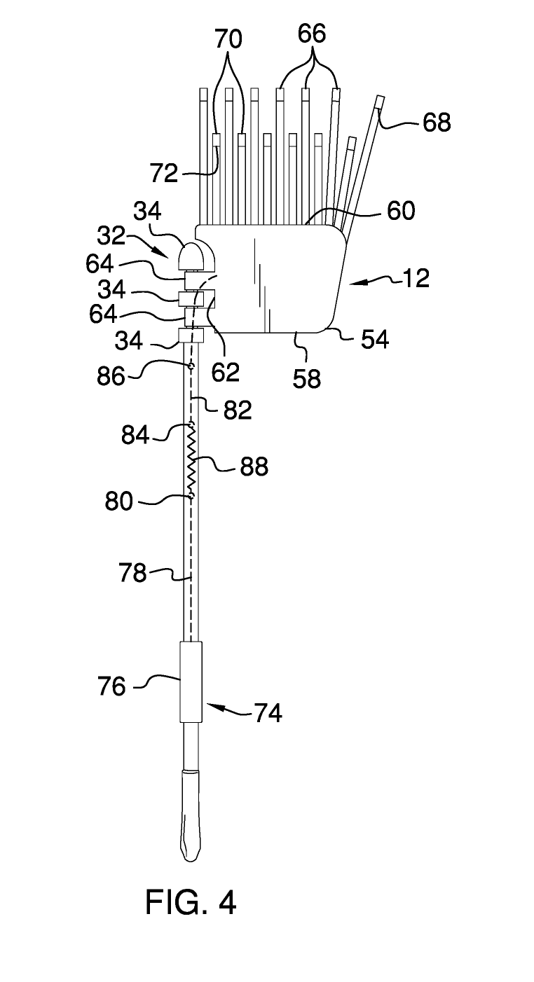

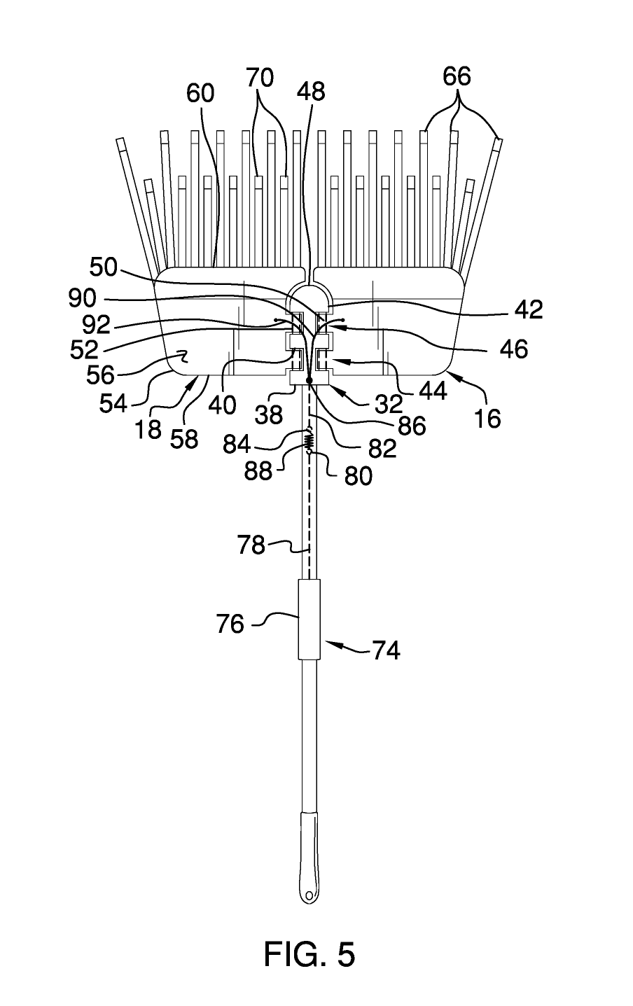

With reference now to the drawings, and in particular to FIGS. 1 through 5 thereof, a new rake device embodying the principles and concepts of an embodiment of the disclosure and generally designated by the reference numeral 10 will be described.

As best illustrated in FIGS. 1 through 5, the rake assembly 10 generally comprises a raking unit 12. The raking unit 12 may be manipulated thereby facilitating the raking unit 12 to rake debris 14. The debris 14 may be leaves on a lawn or the like. The raking unit 12 has a first half 16 and a second half 18. Each of the first half 16 and the second half 18 is positionable in a closed position to grip 26 the debris 14. Thus, the debris 14 may be selectively dumped.

The raking unit 12 comprises a handle 20. The handle 20 has a first end 22 and a second end 24. The handle 20 is elongated between the first end 22 and the second end 24. The second end 24 is open and the handle 20 is substantially hollow. A grip 26 is coupled to the second end 24 of the handle 20 and the grip 26 may be gripped. The grip 26 has a free end 28 with respect to the handle 20. The free end 28 has an opening 30 extending therethrough to be suspended on a support.

A head 32 is provided. The head 32 has a plurality of spaced disks 34 and a central member 36 extending between the spaced disks 34. The plurality of spaced disks 34 includes a bottom disk 38, a medial disk 40 and a top disk 42. The spaced disks 34 are distributed on the central member 36 to define a first space 44 between the bottom disk 38 and the medial disk 40. The spaced disks 34 further define a second space 46 between the medial disk 40 and the top disk 42. The bottom disk 38 is coupled to the second end 24 of the handle 20. The top disk 42 has a top surface 48 and the top surface 48 may be arcuate such that the top disk 42 has a bullet shape.

A first shaft 50 extends between the bottom disk 38, the medial disk 40 and the top disk 42. The first shaft 50 extends through the first space 44 and the second space 46. The first shaft 50 is spaced from the central member 36. A second shaft 52 extends between the bottom disk 38, the medial disk 40 and the top disk 42. The second shaft 52 extends through the first space 44 and the second space 46. The second shaft 52 is spaced from the central member 36 and the second shaft 52 is oppositionally positioned on the head 32 with respect to the first shaft 50.

Each of the first half 16 and the second half 18 of the raking unit 12 comprises a panel 54 that has a first surface 56 and a peripheral edge 58. The peripheral edge 58 has a top side 60 and a first lateral side 62. The panel 54 has a pair of fingers 64 and each of the fingers 64 extends outwardly from the first lateral side 62. The fingers 64 are spaced apart from each other.

Each of the fingers 64 extends into an associated one of the first space 44 and the second space 46. Each of the fingers 64 corresponding to the first half 16 rotatably engages the first shaft 50. Thus, the panel 54 corresponding to the first half 16 is movably coupled to the first shaft 50. Each of the fingers 64 corresponding to the second half 18 rotatably engages the second shaft 52. Thus, the panel 54 corresponding to the second half 18 is movably coupled to the second shaft 52.

The panel 54 corresponding to each of the first half 16 and the second half 18 is selectively positioned in an open position. Thus, the first surface 56 of the first half 16 lies on a plane that is coplanar with the first surface 56 of the second half 18. The panel 54 corresponding to each of the first half 16 and the second half 18 is selectively positioned in a closed position. Thus, the first surface 56 of the first half 16 faces the first surface 56 of the second half 18.

Each of the first half 16 and the second half 18 include a plurality of first tines 66. Each of the first tines 66 is coupled to and extends away from the top side 60 of the panel 54. Each of the first tines 66 has a distal end 68 with respect to the panel 54. Each of the first tines 66 is curved between the panel 54 and the distal end 68. Thus, the distal end 68 may frictionally engage the debris 14. The first tines 66 are spaced apart from each other and are distributed along the top side 60.

Each of the first half 16 and the second half 18 include a plurality of second tines 70. Each of the second tines 70 is coupled to and extends away from the top side 60 of the panel 54. Each of the second tines 70 has a distal end 72 with respect to the panel 54. Each of the second tines 70 is curved between the panel 54 and the distal end 72 of the second tines 70. Thus, the distal end 72 of the second tines 70 may frictionally engage the debris 14. The second tines 70 are spaced apart from each other and are distributed between the first tines 66. Each of the first tines 66 may have a length that is greater than a length of each of the second tines 70.

A closing unit 74 is provided. The closing unit 74 is movably coupled to the raking unit 12 and the closing unit 74 may be manipulated. The closing unit 74 is operationally coupled to each of the first half 16 and the second half 18. Thus, the closing unit 74 selectively positions each of the first half 16 and the second half 18 in the closed position when the closing unit 74 is manipulated.

The closing unit 74 comprises a sleeve 76 that is slidably positioned around the handle 20. Thus, the sleeve 76 may be manipulated. The sleeve 76 is selectively urged into a closing position having the sleeve 76 being slid toward the first end 22 of the handle 20. The sleeve 76 is biased into an opening position having the sleeve 76 being centrally positioned on the handle 20.

A first cord 78 is positioned within the handle 20. The first cord 78 is coupled to the sleeve 76. The first cord 78 has a distal end 80 with respect to the sleeve 76. A second cord 82 is positioned within the handle 20. The second cord 82 has a primary end 84 and a secondary end 86.

A first biasing member 88 is positioned within the handle 20. The first biasing member 88 is coupled between the distal end 80 of the first cord 78 and the primary end 84 of the second cord 82. The first biasing member 88 biases the sleeve 76 into the opening position. The first biasing member 88 may comprise a spring or the like.

A second biasing member 90 is provided. The second biasing member 90 extends outwardly from bottom disk 38 of the head 32. The second biasing member 90 is coupled between the secondary end 86 of the second cord 82 and the first surface 56 corresponding to the first half 16. The second biasing member 90 biases the first half 16 into the open position.

A third biasing member 92 is provided. The third biasing member 92 extends outwardly from the bottom disk 38 of the head 32. The third biasing member 92 is coupled between the secondary end 86 of the second cord 82 and the first surface 56 corresponding to the second half 18. The third biasing member 92 biases the second half 18 into the open position. Each of the first half 16 and the second half 18 is urged into the closed position when the sleeve 76 is urged into the closing position.

Each of the second biasing member 90 and the third biasing member 92 may be comprised of a resiliently bendable material. The second biasing member 90 is biased to curve outwardly between the second cord 82 and the first half 16. The third biasing member 92 is biased to curve outwardly between the second cord 82 and the second half 18. Each of the second 90 and third 92 biasing members is drawn into the handle 20 when the sleeve 76 is urged into the closing position. Moreover, each of the second 90 and third 92 biasing members is straightened when the sleeve 76 is urged into the closing position. Thus, each of the first half 16 and the second half 18 is biased into the open position when the sleeve 76 is biased into the opening position.

In use, the handle 20 is gripped and the raking unit 12 is manipulated. Thus, each of the first tines 66 and the second tines 70 rake the debris 14. The second tines 70 inhibit the debris 14 from passing between the first tines 66. Thus, efficiency of the raking unit 12 is enhanced with respect to raking the debris 14. The sleeve 76 is selectively urged into the closing position. Thus, each of the first half 16 and the second half 18 closes around the debris 14. The sleeve 76 is released and each of the first half 16 and the second half 18 are biased into the open position. Thus, the debris 14 is selectively dumped into a container or the like. The raking unit 12 inhibits bending over to gather and dump the debris 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rake assembly being positionable in a closed position wherein said assembly is configured to grip debris, said assembly comprising:
a raking unit being configured to be manipulated thereby facilitating said raking unit to rake debris, said raking unit having a first half and a second half, each of said first half and said second half being positionable in a closed position wherein each of said first half and said second half is configured to grip the debris thereby facilitating the debris to be selectively dumped; and
a closing unit being movably coupled to said raking unit wherein said closing unit is configured to be manipulated, said closing unit being operationally coupled to each of said first half and said second half such that said closing unit selectively positions each of said first half and said second half in said closed position when said closing unit is manipulated.

2. The assembly according to claim 1, wherein said raking unit comprises:
a handle having a first end and a second end, said handle being elongated between said first end and said second end, said second end being open, said handle being substantially hollow; and
a head having a plurality of spaced disks and a central member extending between said spaced disks, said plurality of spaced disks including a bottom disk, a medial disk, and a top disk, said spaced disks being distributed on said central member to define a first space between said bottom disk and said medial disk and a second space between said medial disk and said top disk, said bottom disk being coupled to said second end of said handle.

3. The assembly according to claim 2, further comprising a first shaft extending between said bottom disk, said medial disk and said top disk having said first shaft extending through said first space and said second space, said first shaft being spaced from said central member.

4. The assembly according to claim 3, further comprising a second shaft extending between said bottom disk, said medial disk and said top disk having said second shaft extending through said first space and said second space, said second shaft being spaced from said central member, said second shaft being oppositionally positioned on said head with respect to said first shaft.

5. The assembly according to claim 2, wherein each of said first half and said second half of said raking unit comprises a panel having a first surface and a peripheral edge, said peripheral edge having a top side and a first lateral side, said panel having a pair of fingers, each of said fingers extending outwardly from said first lateral side, said fingers being spaced apart from each other, each of said fingers extending into an associated one of said first space and said second space.

6. The assembly according to claim 5, wherein:
said head includes a first shaft; and
each of said fingers corresponding to said first half rotatably engages said first shaft such that said panel corresponding to said first half is movably coupled to said first shaft.

7. The assembly according to claim 5, wherein:
said head includes a second shaft; and
each of said fingers corresponding to said second half rotatably engages said second shaft such that said panel corresponding to said second half is movably coupled to said second shaft.

8. The assembly according to claim 5, wherein said panel corresponding to each of said first half and said second half being selectively positioned in an open position having said first surface of said first half lying on a plane being coplanar with said first surface of said second half, said panel corresponding to each of said first half and said second half being selectively positioned in a closed position having said first surface of said first half facing said first surface of said second half.

9. The assembly according to claim 5, further comprising a plurality of first tines, each of said first tines being coupled to and extending away from said top side of said panel, each of said first tines having a distal end with respect to said panel, each of said first tines being curved between said panel and said distal end wherein said distal end is configured to frictionally engage the debris, said first tines being spaced apart from each other and being distributed along said top side.

10. The assembly according to claim 9, further comprising a plurality of second tines, each of said second tines being coupled to and extending away from said top side of said panel, each of said second tines having a distal end with respect to said panel, each of said second tines being curved between said panel and said distal end of said second tines wherein said distal end of said second tines is configured to frictionally engage the debris, said second tines being spaced apart from each other and being distributed between said first tines.

11. The assembly according to claim 1, wherein:
said raking unit includes a handle having a first end; and
said closing unit comprises a sleeve being slidably positioned around said handle wherein said sleeve is configured to be manipulated, said sleeve being selectively urged into a closing position having said sleeve being slid toward said first end of said handle, said sleeve being biased into an opening position having said sleeve being centrally positioned on said handle.

12. The assembly according to claim 11, further comprising a first cord being positioned within said handle, said first cord being coupled to said sleeve, said first cord having a distal end with respect to said sleeve.

13. The assembly according to claim 11, further comprising a second cord being positioned within said handle, said second cord having a primary end and a secondary end.

14. The assembly according to claim 13, further comprising:
a first cord having a distal end; and
a first biasing member being positioned within said handle, said first biasing member being coupled between said distal end of said first cord and said primary end of said second cord, said first biasing member biasing said sleeve into said opening position.

15. The assembly according to claim 13, further comprising:
a head having a bottom disk; and
a second biasing member extending outwardly from bottom disk of said head, said second biasing member being coupled between said secondary end of said second cord and a first surface corresponding to said first half, said second biasing member biasing said first half into said open position.

16. The assembly according to claim 13, further comprising:
a head having a bottom disk; and
a third biasing member extending outwardly from said bottom disk of said head, said third biasing member being coupled between said secondary end of said second cord and said first surface corresponding to said second half, said third biasing member biasing said second half into said open position, each of said first half and said second half being urged into said closed position when said sleeve is urged into said closing position, each of said first half and said second half being biased into said open position when said sleeve is biased into said opening position.

17. A rake assembly being positionable in a closed position wherein said assembly is configured to grip debris, said assembly comprising:
a raking unit being configured to be manipulated thereby facilitating said raking unit to rake debris, said raking unit having a first half and a second half, each of said first half and said second half being positionable in a closed position wherein each of said first half and said second half is configured to grip the debris thereby facilitating the debris to be selectively dumped, said raking unit comprising:
a handle having a first end and a second end, said handle being elongated between said first end and said second end, said second end being open, said handle being substantially hollow,
a head having a plurality of spaced disks and a central member extending between said spaced disks, said plurality of spaced disks including a bottom disk, a medial disk, and a top disk, said spaced disks being distributed on said central member to define a first space between said bottom disk and said medial disk and a second space between said medial disk and said top disk, said bottom disk being coupled to said second end of said handle,
a first shaft extending between said bottom disk, said medial disk and said top disk having said first shaft extending through said first space and said second space, said first shaft being spaced from said central member,
a second shaft extending between said bottom disk, said medial disk and said top disk having said second shaft extending through said first space and said second space, said second shaft being spaced from said central member, said second shaft being oppositionally positioned on said head with respect to said first shaft,
each of said first half and said second half of said raking unit comprising:
a panel having a first surface and a peripheral edge, said peripheral edge having a top side and a first lateral side, said panel having a pair of fingers, each of said fingers extending outwardly from said first lateral side, said fingers being spaced apart from each other, each of said fingers extending into an associated one of said first space and said second space, each of said fingers corresponding to said first half rotatably engaging said first shaft such that said panel corresponding to said first half is movably coupled to said first shaft, each of said fingers corresponding to said second half rotatably engaging said second shaft such that said panel corresponding to said second half is movably coupled to said second shaft, said panel corresponding to each of said first half and said second half being selectively positioned in an open position having said first surface of said first half lying on a plane being coplanar with said first surface of said second half, said panel corresponding to each of said first half and said second half being selectively positioned in a closed position having said first surface of said first half facing said first surface of said second half,
a plurality of first tines, each of said first tines being coupled to and extending away from said top side of said panel, each of said first tines having a distal end with respect to said panel, each of said first tines being curved between said panel and said distal end wherein said distal end is configured to frictionally engage the debris, said first tines being spaced apart from each other and being distributed along said top side,
a plurality of second tines, each of said second tines being coupled to and extending away from said top side of said panel, each of said second tines having a distal end with respect to said panel, each of said second tines being curved between said panel and said distal end of said second tines wherein said distal end of said second tines is configured to frictionally engage the debris, said second tines being spaced apart from each other and being distributed between said first tines; and
a closing unit being movably coupled to said raking unit wherein said closing unit is configured to be manipulated, said closing unit being operationally coupled to each of said first half and said second half such that said closing unit selectively positions each of said first half and said second half in said closed position when said closing unit is manipulated, said closing unit comprising:
a sleeve being slidably positioned around said handle wherein said sleeve is configured to be manipulated, said sleeve being selectively urged into a closing position having said sleeve being slid toward said first end of said handle, said sleeve being biased into an opening position having said sleeve being centrally positioned on said handle,
a first cord being positioned within said handle, said first cord being coupled to said sleeve, said first cord having a distal end with respect to said sleeve,
a second cord being positioned within said handle, said second cord having a primary end and a secondary end,
a first biasing member being positioned within said handle, said first biasing member being coupled between said distal end of said first cord and said primary end of said second cord, said first biasing member biasing said sleeve into said opening position,
a second biasing member extending outwardly from bottom disk of said head, said second biasing member being coupled between said secondary end of said second cord and said first surface corresponding to said first half, said second biasing member biasing said first half into said open position, and
a third biasing member extending outwardly from said bottom disk of said head, said third biasing member being coupled between said secondary end of said second cord and said first surface corresponding to said second half, said third biasing member biasing said second half into said open position, each of said first half and said second half being urged into said closed position when said sleeve is urged into said closing position, each of said first half and said second half being biased into said open position when said sleeve is biased into said opening position.
